(19) United States
(12) Patent Application Publication
(10) Pub. No.: US 2024/0025331 A1
(43) Pub. Date: Jan. 25, 2024

(54) Slotted Tie Down Protector

(71) Applicant: Complete Packaging Systems Inc., Whitby (CA)

(72) Inventor: Darren Burden, Whitby (CA)

(73) Assignee: Complete Packaging Systems Inc., Whitby (CA)

(21) Appl. No.: 17/870,289

(22) Filed: Jul. 21, 2022

(51) Int. Cl. B60P 7/08; B65D 71/04

(52) U.S. Cl. CPC B60P 7/0869; B65D 71/04; B65D 2571/00117

(57) ABSTRACT

A slotted tie down protector assembly according to the invention is provided and is generally constructed to include a securing plate, a webbing and a tension buckle. The securing plate is an elongated rectangular member and further includes a set of dual elongated oval shaped receiving passages in the central region. The webbing includes a set of end pieces at each end and are threaded through each of the oval shaped receiving passages. The securing plate is placed on the corner or side of a cargo container and the end pieces of the webbing are pulled in order to create tension. The tension buckle is fastened to the body of the webbing and engaged in order to tighten the webbing to create a greater level of tension within the assembly.

### FIELD OF INVENTION

The invention relates to a slotted tie down protector assembly and, more particularly, to a slotted tie down protector assembly for securing various sized and shaped cargo containers.

### BACKGROUND

When transporting cargo containers, in various transporting vehicles, it is difficult to avoid the occasion of a cargo container tipping, falling over, or crushing other containers in transit without using the proper restraints. Currently, strapping machines are used to automatically apply straps around the cargo. However, the strapping machines tend to sometimes faulter. When this happens, contents of containers can spill onto the floor or onto other cargo containers in the vicinity thereby damaging other cargo's contents or the transport vehicle's inner holding area. Therefore, it is a problem in the transportation industry to ensure that different sized and shaped containers are secured while in transit.

Thus, there remains a need for an assembly that would ensure that the containers are secured and prevent the cargo containers from tipping, falling over, or spilling its contents during transport.

### SUMMARY

A slotted tie down protector assembly according to the invention is provided and is generally constructed to comprise a securing plate pressed firmly against a container and having a set of elongated oval shaped receiving passages positioned on opposite ends thereof; an elongated rectangular member of the securing plate having: a first surface; a second surface; and a crease which is scored, and which runs latitudinally in between the first surface and the second surface on a first face; a webbing positioned about the container and threaded through the securing plate thereof; a first end piece of the webbing is threaded along the first surface of the elongated rectangular member through an elongated oval shaped receiving passageway; and a second end piece of the webbing is threaded along the second surface of the elongated rectangular member through an elongated oval shaped receiving passage; and a tension is created by pulling the first end piece and the second end piece in opposite directions; and a tension buckle is used for tightening the webbing.

### BRIEF DESCRIPTION OF THE DRAWINGS

The invention will now be described by way of example with reference to the accompanying Figures of which:

FIG. 1 is a perspective view of the slotted tie down protector assembly being implemented inside a shipping container;

FIG. 2 is an enlarged perspective view of the invention of FIG. 1;

FIG. 3 is a top perspective view of the invention of FIG. 2;

FIG. 4 is an enlarged view of the invention of FIG. 3;

FIG. 5 is a top view of the invention of FIG. 4;

FIG. 6 is a perspective view of the invention of FIG. 5 being implemented inside a shipping container;

FIG. 7 is a perspective view of the invention of FIG. 6; and

FIG. 8 is a top view of the invention of FIG. 7.

### DETAILED DESCRIPTION OF THE INVENTION

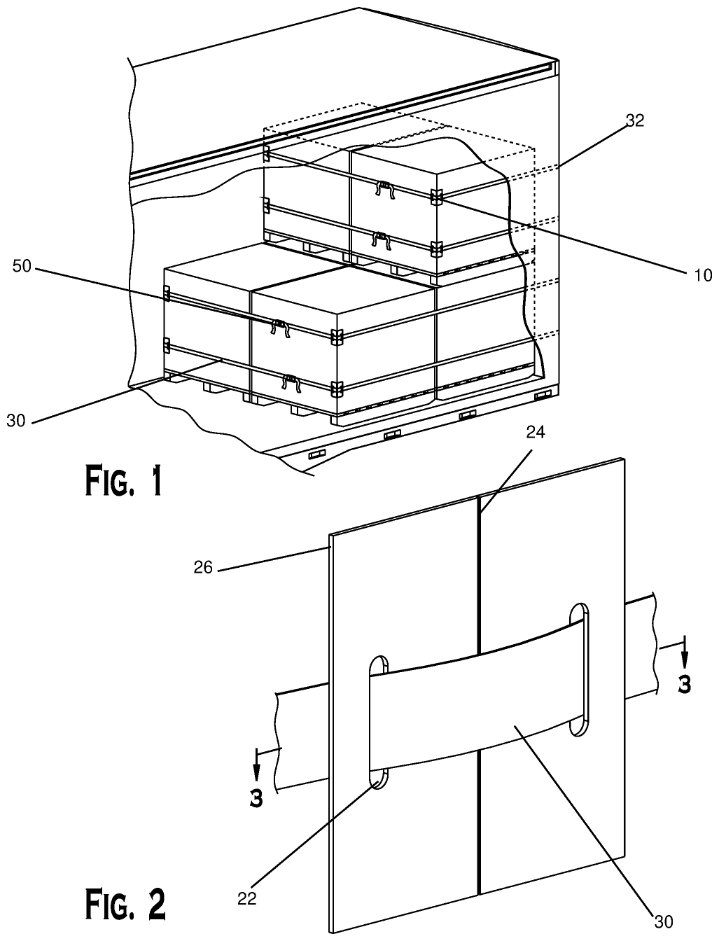

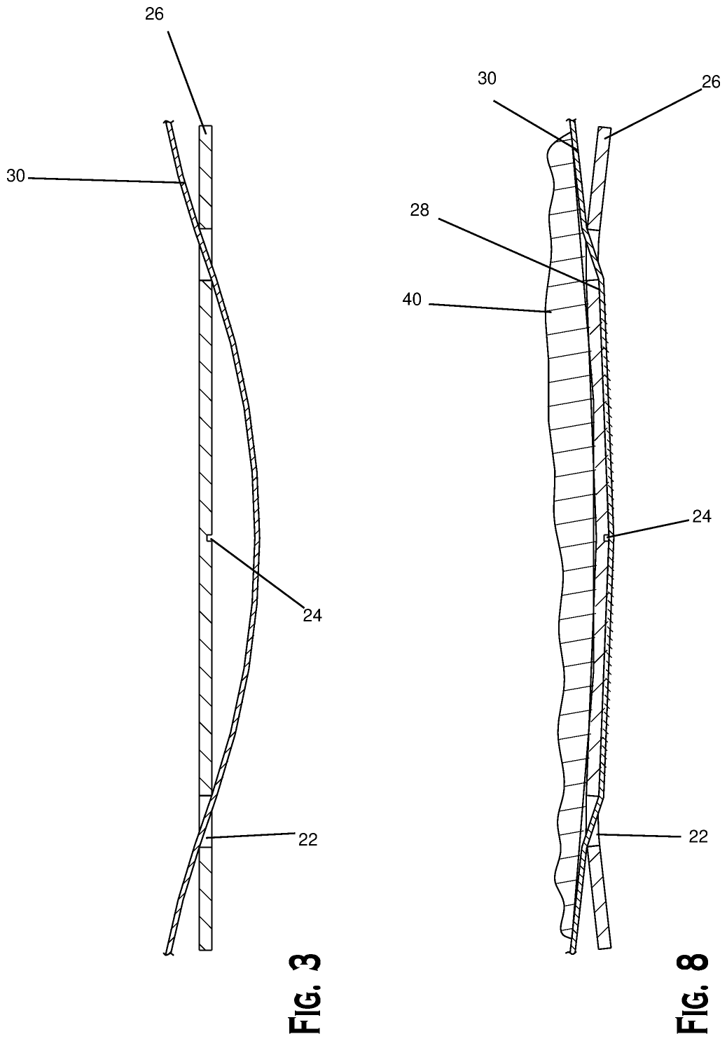

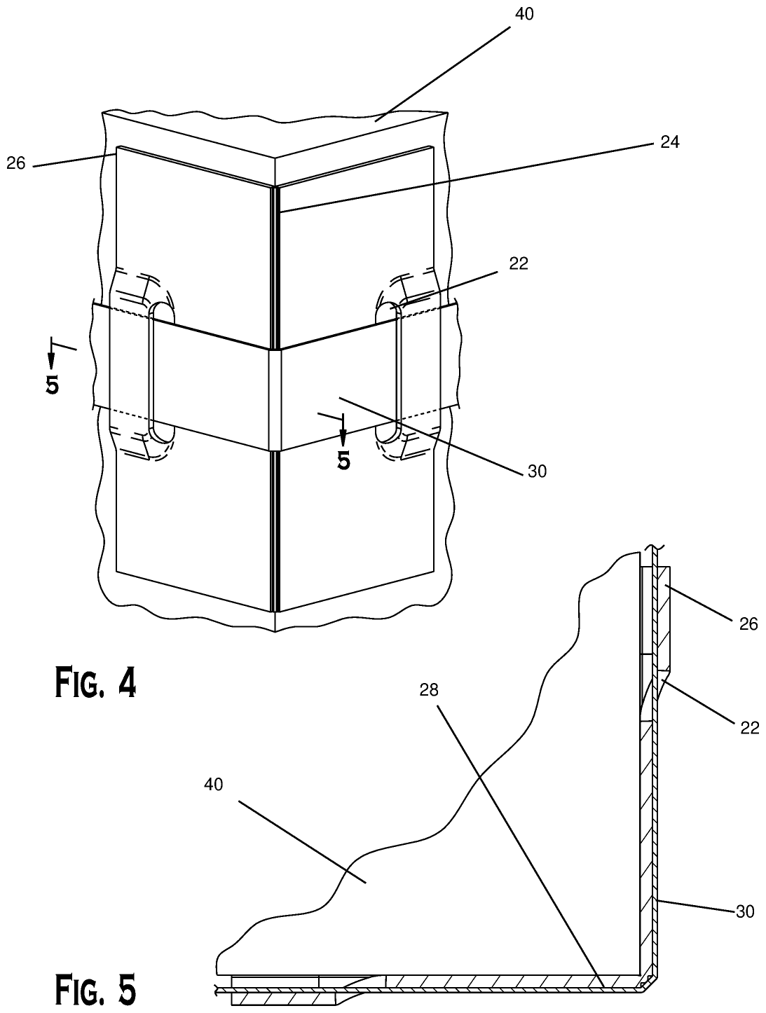

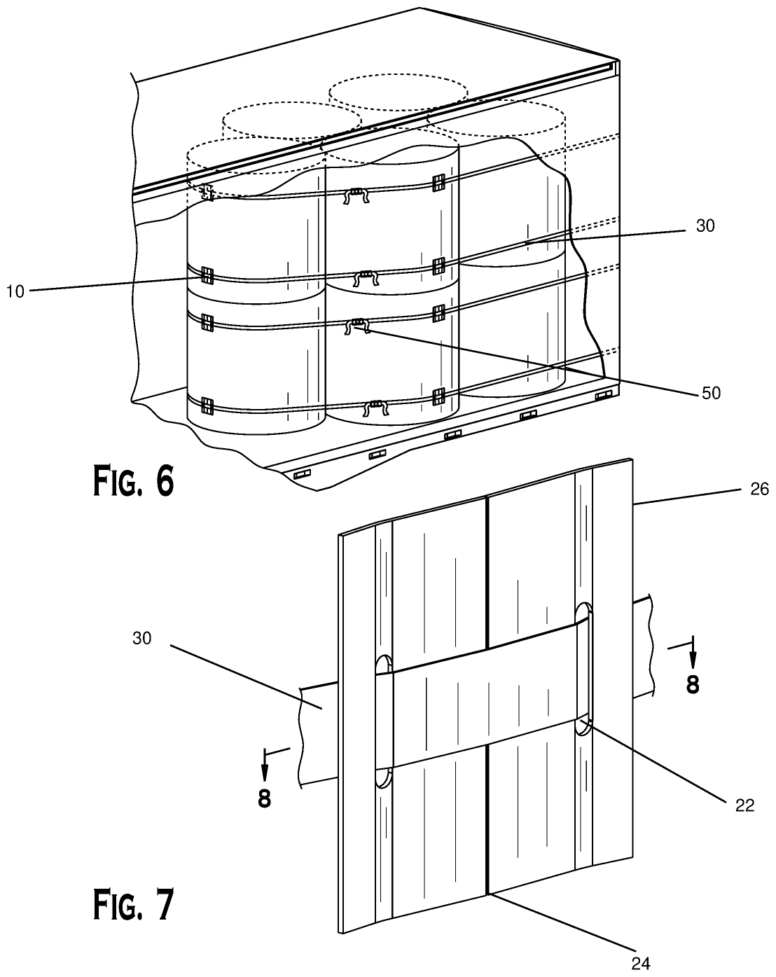

Referring to FIGS. 1-8, a slotted tie down protector assembly 10, is generally constructed in accordance with the following major components: a securing plate 20, a webbing and a tension buckle 50.

In the exemplary embodiment, the securing plate 20 is a flexible plate like member and, as shown, includes an elongated rectangular member 26. One of ordinary skill in the art would understand the applicant's design of the securing plate 20 is not the exclusive embodiment and other designs can be used for the securing plate 20. In the exemplary embodiment shown, the material of the elongated rectangular member 26 is cardboard. One of ordinary skill in the art would understand the applicant's choice of material is not the exclusive embodiment and other materials can be used. In the exemplary embodiment, the rectangular member 26 is twenty-four (24) inches long and two (2) inches wide. One of ordinary skill in the art would understand the applicant's dimensions of the rectangular member 26 is not the exclusive embodiment.

In the exemplary embodiment, the elongated rectangular member 26 includes a first surface and a second surface adjacent the first surface. In the exemplary embodiment, the elongated rectangular member 26 further includes a first face and a second face opposite the first face. In the exemplary embodiment, the elongated rectangular member 26 further includes a crease 24 running vertically along the central region. In the shown embodiment, the crease 24 is a ¾ score that runs through the middle of the elongated rectangular member 26 and extends latitudinally on the first face. One of ordinary skill in the art would understand the crease 24 can vary in lengths and depths and applicant's design is not the exclusive embodiment. In the exemplary embodiment, the elongated rectangular member 26 further includes a set of elongated oval shaped receiving passage 22 positioned on opposite sides of the crease 24. One of ordinary skill in the art would understand the applicant's design of the elongated oval shaped receiving passages 22 is not the exclusive embodiment. In one embodiment, the elongated rectangular member 26 further includes a grip 28 on the second face. The grip 28 is a standard grip. One of ordinary skill in the art would understand the applicant's design of the grip is not the exclusive embodiment.

In the exemplary embodiment, the webbing 30 is a standard webbing. One of ordinary skill in the art would understand the applicant's design of the webbing 30 is an exemplary embodiment and the webbing 30 may be an elastically resilient strap that maintains elasticity when moved between first position and second position. In the exemplary embodiment, the webbing 30 further includes a set of end pieces 32 at each end thereof. One of ordinary skill in the art would understand the applicant's design of the end piece 32 is not the exclusive embodiment.

In the exemplary embodiment, a tension buckle 50 is a standard ratchet. One of ordinary skill in the art would understand the tension buckle 50 is any ratchet that can supply further tension to the webbing 30 such as a ladder buckle, a wire buckle, etc.

In the exemplary embodiment, the slotted tie down protector assembly 10, is generally constructed in accordance with the following major components: a securing plate 20, webbing 30 and a tension buckle 50. In the exemplary embodiment, the set of end pieces 32 and the webbing are threaded through the set of elongated oval shaped receiving passages 22. In the exemplary embodiment, the tension buckle 50 is connected to the body of the webbing 30.

In the exemplary embodiment, the slotted tie down protector assembly 10 can be used for various sized and shaped cargo containers 40 and can switch between first position and second position. While in first position, the securing plate 20 and the webbing 30 are at rest. When the assembly 10 is ready to be used for angled cargo containers 40, the slotted tie down protector assembly 10 is then placed in second position. In the exemplary embodiment, the crease 24 of the elongated rectangular member 26 is pressed firmly against the corner edge of the angled cargo container 40. In the exemplary embodiment, the second face of the elongated rectangular member 26 is then pivoted around the corner of the container 40. In the exemplary embodiment, the grip 28 is pressed firmly to the cargo container 40. In the exemplary embodiment, the set of end pieces 32 of the webbing 30 are pulled from both sides to create tension within the slotted tie down protector assembly 10. In the exemplary embodiment, the set of end pieces 32 are fastened to a transport or threaded through another slotted tie down protector assembly 10 in order to secure more cargo containers 40. In the exemplary embodiment, the tension created, firmly presses the slotted tie down protector assembly 10 against the cargo container 40. In the exemplary embodiment, the tension buckle 50 is engaged to allow tightening of the webbing 30 and create a greater level of tension to the whole assembly 10.

In the exemplary embodiment, when using the slotted tie down protector assembly 10 for cargo containers 40 with rounded edging, the slotted tie down protector assembly 10 is first brought into first position. When the slotted tie down protector assembly 10 is ready to be used, the crease 24 is pressed firmly against the cargo container 40. In the exemplary embodiment, the second face of the elongated rectangular member 26 is pressed firmly against the outside of the rounded edging of the cargo container 40 using the grip 28. In the exemplary embodiment, the elongated rectangular member 26 forms to the outer edge of the container 40 and switches to second position. In the exemplary embodiment, the set of end pieces 32 of the webbing 30 are pulled from both sides to create tension within the slotted tie down protector assembly 10. In the exemplary embodiment, the set of end pieces 32 are fastened to a transport or threaded through another slotted tie down protector assembly 10 in order to secure more cargo container 40. In the exemplary embodiment, the tension buckle 50 is engaged to allow tightening of the webbing 30 and create a greater level of tension to the whole assembly 10.

In the exemplary embodiment, the slotted tie down protector assembly 10 can be also used between different shaped containers 40. In the exemplary embodiment, if the user requires the need to secure containers of different shapes, the slotted tie down protector assembly 10 can be used and provide security even when not transporting containers 40 of the same shape.

The foregoing illustrates some of the possibilities for practicing the invention. Many other embodiments are possible within the scope and spirit of the invention. It is, therefore, intended that the foregoing description be regarded as illustrative rather than limiting and that the scope of invention is given by the appended claims together with their full range of equivalents.

What is claimed is:

1. A slotted tie down protector assembly comprising:
a securing plate pressed firmly against a container and having a set of elongated oval shaped receiving passages positioned on opposite ends thereof;
an elongated rectangular member of the securing plate having:
a first surface;
a second surface; and
a crease which is scored, and which runs latitudinally in between the first surface and the second surface on a first face;
a webbing positioned about the container and threaded through the securing plate thereof;
a first end piece of the webbing is threaded along the first surface of the elongated rectangular member through an elongated oval shaped receiving passageway; and
a second end piece of the webbing is threaded along the second surface of the elongated rectangular member through an elongated oval shaped receiving passage; and
a tension is created by pulling the first end piece and the second end piece in opposite directions; and
a tension buckle is used for tightening the webbing.

2. The slotted tie down protector assembly of claim 1, wherein the securing plate can switch between a first position and a second position.

3. The slotted tie down protector assembly of claim 2, wherein the webbing can switch between a first position and a second position.

4. The slotted tie down protector assembly of claim 3, wherein the elongated rectangular member includes at least one elongated oval shaped receiving passageway.

5. The slotted tie down protector assembly of claim 4, wherein the elongated rectangular member is composed of cardboard.

6. The slotted tie down protector assembly of claim 5, wherein the crease is a ¾ score running through the middle elongated rectangular member on the first face.

7. The slotted tie down protector assembly of claim 6, wherein the elongated rectangular member further includes a grip on the second face thereof.

8. The slotted tie down protector assembly of claim 7, wherein the elongated rectangular member is pivotable.

9. The slotted tie down protector assembly of claim 8, wherein the webbing includes the set of end pieces on each end thereof.

10. The slotted tie down protector assembly of claim 9, wherein the webbing may be formed in an elastically resilient manner and maintain elasticity when moved between the first position and the second position.

11. The slotted tie down protector assembly of claim 10, wherein the tension buckle is connected to a body of the webbing.

12. The slotted tie down protector assembly of claim 11, wherein the tension buckle provides a greater level of tension.

13. The slotted tie down protector assembly of claim 12, wherein the first end piece is fastened to a side of a transport.

14. The slotted tie down protector assembly of claim 14, wherein the second end piece is fastened to a second side of the transport.

15. The slotted tie down protector assembly of claim 15, wherein multiple slotted tie down assemblies can used jointly.
